(19) United States
(12) Patent Application Publication
(10) Pub. No.: US 2026/0049547 A1
(43) Pub. Date: Feb. 19, 2026

(54) Method and Device for Determining the Settling Rate of Proppant

(71) Applicants: China University of Petroleum (Beijing), Houston, TX (US); STenergy LLC, Houston, TX (US)

(72) Inventors: Li Ben, Beijing (CN); Quanjun Wang, Cypress, TX (US); Li Hui, Beijing (CN)

(73) Assignee: STenergy LLC, Houston, TX (US)

(21) Appl. No.: 19/243,699

(22) Filed: Jun. 20, 2025

(30) Foreign Application Priority Data
Aug. 13, 2024 (CN) 202411107027

(51) Int. Cl. E21B 47/00; C09K 8/80; E21B 43/267

(52) U.S. Cl. CPC E21B 47/00; C09K 8/80; E21B 43/267

(57) ABSTRACT

The present application discloses a method and apparatus for determining the settling rate of proppants in hydraulic fracturing. The method comprises: acquiring the target mesh size of the proppant; obtaining the bulk density of the proppant, and the density and viscosity of the carrier fluid under reservoir conditions; retrieving the proppant concentration (sand ratio) during injection; and applying a pre-established predictive model specific to the selected mesh size. The model inputs include proppant bulk density, carrier fluid density, reservoir-temperature viscosity, and sand ratio, and the output is the estimated settling velocity. This method effectively addresses the technical challenge of predicting proppant transport behavior under downhole conditions, thereby enhancing proppant placement accuracy and improving fracture conductivity in low-permeability formations.

### TECHNICAL FIELD

The present application relates to the technical field of oil and gas production, and more particularly to a method and device for determining the settling rate of proppant.

### BACKGROUND OF THE INVENTION

The objective of hydraulic fracturing in unconventional reservoirs is to create fractures with certain conductivity in low-permeability or ultra-low-permeability reservoirs. The conductivity of the fractures is generally established by pumping proppants of a certain mesh size into the fractures. The placement of proppant within the fractures determines the fracture conductivity, which in turn affects the production enhancement after fracturing. Furthermore, the settling rate of the proppant directly influences the placement effect. In actual operations, if the settling rate of the proppant is too high, it may cause premature sand plugging near the wellbore, thereby affecting proppant placement in the far end of the fracture. If the settling rate is too low, excessive proppant may migrate to the fracture tip, resulting in poor placement efficiency near the wellbore, leading to fracture closure near the wellbore after fracturing and adversely affecting hydrocarbon flow pathways.

At present, there is no effective solution for accurately determining the settling rate of proppant to improve fracture placement efficiency.

### SUMMARY OF THE INVENTION

The objective of the present application is to provide a method and device for determining the settling rate of proppant, which can accurately determine the settling rate of proppant, thereby improving the placement effect of the proppant.

The method and device for determining the settling rate of proppant provided by the present application are implemented as follows:

A method for determining the settling rate of proppant, comprising:
acquiring the mesh size of the proppant as a predetermined mesh size;
obtaining the bulk density of the proppant with the predetermined mesh size, the density of the carrier fluid, and the viscosity of the carrier fluid at reservoir temperature;
obtaining a preset sand ratio for pumping the proppant with the predetermined mesh size;
retrieving a pre-established settling rate calculation model corresponding to the proppant of the predetermined mesh size;
inputting the bulk density of the proppant with the predetermined mesh size, the carrier fluid density, the viscosity of the carrier fluid at reservoir temperature, and the sand ratio into the settling rate calculation model for the predetermined mesh size proppant, and calculating the settling rate of the proppant with the predetermined mesh size.

In one embodiment, the mesh size of the proppant comprises at least one of: 30/50, 40/70, 70/140, or 100/200.

In one embodiment, the settling rate calculation model for the proppant with the predetermined mesh size comprises:
when the predetermined mesh size of the proppant is 30/50, the corresponding settling rate calculation model is expressed as:

$${v}_{p 30 / 50} = 11 7.83 lg ( {α}_{30 / {50}^{{m}_{30 / 50}}} \frac{{ρ}_{s 30 / 50}}{{ρ}_{l 30 / 50}} ) {e}^{- {n}_{30 / 50} {μ}_{30 / 50}}$$

wherein, v_{p30/50} denotes the settling rate of the proppant with a mesh size of 30/50, α_{30/50} denotes the sand ratio of the proppant with a mesh size of 30/50 during pumping, m_{30/50} denotes the sand ratio factor of the proppant with a mesh size of 30/50, ρ_{s30/50} denotes the bulk density of the proppant with a mesh size of 30/50, ρ_{l30/50} denotes the density of the carrier fluid for the proppant with a mesh size of 30/50, μ_{30/50} denotes the viscosity factor of the proppant with a mesh size of 30/50; ρ_{30/50} denotes the viscosity of the carrier fluid under reservoir temperature for the proppant with a mesh size of 30/50;
when the predetermined mesh size of the proppant is 40/70, the corresponding settling rate calculation model is expressed as:

$${v}_{p 40 / 70} = 7 3.84 lg ( {α}_{40 / 7 {0}^{{m}_{40 / 70}}} \frac{{ρ}_{s 40 / 70}}{{ρ}_{l 40 / 70}} ) {e}^{- {n}_{40 / 70} {μ}_{40 / 70}}$$

wherein, v_{p40/70} denotes the settling rate of the proppant with a mesh size of 40/70, α_{40/70} denotes the sand ratio of the proppant with a mesh size of 40/70 during pumping, m_{40/70} denotes the sand ratio factor of the proppant with a mesh size of 40/70, ρ_{s40/70} denotes the bulk density of the proppant with a mesh size of 40/70, ρ_{l40/70} denotes the density of the carrier fluid for the proppant with a mesh size of 40/70, μ_{40/70} denotes the viscosity factor of the proppant with a mesh size of 40/70, μ_{40/70} denotes the viscosity of the carrier fluid under reservoir temperature for the proppant with a mesh size of 40/70;
In one embodiment, the settling rate calculation model for the proppant with the predetermined mesh size comprises:
when the predetermined mesh size of the proppant is 70/140, the corresponding settling rate calculation model is expressed as:

$${v}_{p 70 / 140} = 2 8.34 lg ( {α}_{70 / {140}^{{m}_{70 / 140}}} \frac{{ρ}_{s 70 / 140}}{{ρ}_{l 70 / 140}} ) {e}^{- {n}_{70 / 140} {μ}_{70 / 140}}$$

wherein, v_{p70/140} denotes the settling rate of the proppant with a mesh size of 70/140, α_{70/140} denotes the sand ratio of the proppant with a mesh size of 70/140 during pumping, m_{70/140} denotes the sand ratio factor of the proppant with a mesh size of 70/140, ρ_{s70/140} denotes the bulk density of the proppant with a mesh size of 70/140, ρ_{l70/140} denotes the density of the carrier fluid for the proppant with a mesh size of 70/140, μ_{70/140} denotes the viscosity factor of the proppant with a mesh size of 70/140, ρ_{70/140} denotes the viscosity of the carrier fluid under reservoir temperature for the proppant with a mesh size of 70/140;
when the predetermined mesh size of the proppant is 100/200, the corresponding settling rate calculation model is expressed as:

$${v}_{p 10 \; 0 / 200} = 6 8.51 lg ( {α}_{100 / 20 {0}^{{m}_{100 / 200}}} \frac{{ρ}_{s 100 / 200}}{{ρ}_{l 10 \; 0 / 200}} ) {e}^{- {n}_{100 / 200} {μ}_{100 / 200}}$$

wherein, v_{p100/200} denotes the settling rate of the proppant with a mesh size of 100/200, α_{100/200} denotes the sand ratio of the proppant with a mesh size of 100/200 during pumping, m_{100/200} denotes the sand ratio factor of the proppant with a mesh size of 100/200, ρ_{s100/200} denotes the bulk density of the proppant with a mesh size of 100/200, ρ_{l100/200} denotes the density of the carrier fluid for the proppant with a mesh size of 100/200, n_{100/200} denotes the viscosity factor of the proppant with a mesh size of 100/200, μ_{100/200} denotes the viscosity of the carrier fluid under reservoir temperature for the proppant with a mesh size of 100/200.

In one embodiment, obtaining the viscosity of the carrier fluid at reservoir temperature comprises:
determining and calculating the viscosity of the carrier fluid at reservoir temperature according to the following formula:

$$μ = {μ}_{0} \cdot {e}^{( T - {T}_{0} ) / {T}_{0}}$$

wherein, μ denotes the viscosity of the carrier fluid under reservoir temperature, μ₀ denotes the viscosity of the carrier fluid under surface temperature, T denotes the temperature of the target formation, T₀ denotes the surface temperature.

In one embodiment, after calculating the settling rate of the proppant with the predetermined mesh size, the method further comprises:
determining whether the calculated settling rate of the proppant with the predetermined mesh size meets a preset settling rate requirement;
if it is determined that the calculated settling rate of the proppant with the predetermined mesh size does not meet the preset settling rate requirement, reselecting the mesh size of the proppant, or adjusting one or more of the bulk density of the proppant, the density of the carrier fluid, and the viscosity of the carrier fluid at reservoir temperature;
determining the settling rate based on the reselected mesh size of the proppant, or based on one or more of the adjusted bulk density of the proppant, the density of the carrier fluid, and the viscosity of the carrier fluid at reservoir temperature, until the settling rate meets the preset settling rate requirement.

A device for determining the settling rate of proppant, comprising:
a first acquisition module configured to acquire the mesh size of the proppant as a predetermined mesh size;
a second acquisition module configured to acquire the bulk density of the proppant with the predetermined mesh size, the density of the carrier fluid, and the viscosity of the carrier fluid at reservoir temperature;
a third acquisition module configured to acquire a preset sand ratio for pumping the proppant with the predetermined mesh size;
a retrieval module configured to retrieve a pre-established settling rate calculation model corresponding to the proppant of the predetermined mesh size;
a calculation module configured to input the bulk density of the proppant with the predetermined mesh size, the carrier fluid density, the viscosity of the carrier fluid at reservoir temperature, and the sand ratio into the settling rate calculation model for the predetermined mesh size proppant, so as to calculate the settling rate of the proppant with the predetermined mesh size.

In one embodiment, the second acquisition module is specifically configured to determine and calculate the viscosity of the carrier fluid at reservoir temperature according to the following formula:

$$μ = {μ}_{0} \cdot {e}^{( T - {T}_{0} ) / {T}_{0}}$$

wherein, μ denotes the viscosity of the carrier fluid under reservoir temperature, μ₀ denotes the viscosity of the carrier fluid under surface temperature, T denotes the temperature of the target formation, T₀ denotes the surface temperature.

An electronic device, comprising a processor and a memory for storing instructions executable by the processor, wherein the processor executes the instructions to perform the steps of the above-described method.

A computer-readable storage medium, storing a computer program/instructions, wherein the computer program/instructions, when executed by a processor, perform the steps of the above-described method.

The method for determining the settling rate of proppant provided by the present application includes: acquiring the mesh size of the proppant as a predetermined mesh size; then obtaining the bulk density of the proppant with the predetermined mesh size, the density of the carrier fluid, and the viscosity of the carrier fluid at reservoir temperature; further obtaining a preset sand ratio for pumping the proppant with the predetermined mesh size; retrieving a pre-established settling rate calculation model corresponding to the proppant of the predetermined mesh size; inputting the bulk density of the proppant, the carrier fluid density, the viscosity of the carrier fluid at reservoir temperature, and the sand ratio into the settling rate calculation model for the predetermined mesh size proppant to calculate the settling rate of the proppant with the predetermined mesh size. In other words, the settling rate is determined by comprehensively considering parameters such as the bulk density of the proppant, the carrier fluid density, and the viscosity of the carrier fluid at reservoir temperature, thereby solving the technical problem of poor proppant placement effect caused by the inability to accurately determine the settling rate in the prior art, and achieving the technical effect of accurately determining the settling rate to improve the proppant placement effect.

### DESCRIPTION OF THE DRAWINGS

In order to more clearly illustrate the technical solutions of the embodiments of the present application or the prior art, the drawings to be used in the description of the embodiments or the prior art will be briefly introduced below. It is apparent that the drawings described below are only some embodiments recorded in the present application, and other drawings may also be obtained by those skilled in art without creative efforts based on these drawings.

FIG. 1 is a flowchart of one embodiment of the method for determining the settling rate of proppant provided by the present application;

FIG. 2 is a schematic diagram showing the relationship between settling rate, sand ratio, and viscosity provided by the present application;

FIG. 3 is a hardware block diagram of an electronic device for determining the settling rate of proppant provided by the present application;

FIG. 4 is a schematic structural diagram of the modules of one embodiment of the device for determining the settling rate of proppant provided by the present application.

### SPECIFIC EMBODIMENTS

In order to enable those skilled in the art to better understand the technical solutions in the present application, the technical solutions of the embodiments in the present application will be clearly and completely described below in conjunction with the accompanying drawings in the embodiments of the present application. Obviously, the described embodiments are only part of the embodiments of the present application, rather than all of the embodiments. Based on the embodiments of the present application, all other embodiments obtained by those of ordinary skill in the art without creative efforts shall fall within the scope of protection of the present application.

It should also be noted that certain existing software, components, models, and other industry-known solutions may be mentioned in the embodiments of the present specification. These should be regarded as exemplary and are intended only to illustrate the feasibility of implementing the technical solutions of the present application, without implying that the applicant has used or necessarily intends to use such solutions.

Considering that the settling rate of the proppant is a major factor affecting the placement of the proppant, and the settling rate is influenced by parameters such as the slurry velocity, the viscosity of the carrier fluid, and the sand ratio, in order to improve the placement effect of the proppant and maximize hydrocarbon production, a method for determining the settling rate of proppant is proposed in the present embodiment. This method enables the accurate determination of the proppant settling rate in unconventional hydraulic fracturing, and also allows for adjustment of the settling rate by changing the proppant density, carrier fluid density, and carrier fluid viscosity, thereby achieving accurate determination of the settling rate.

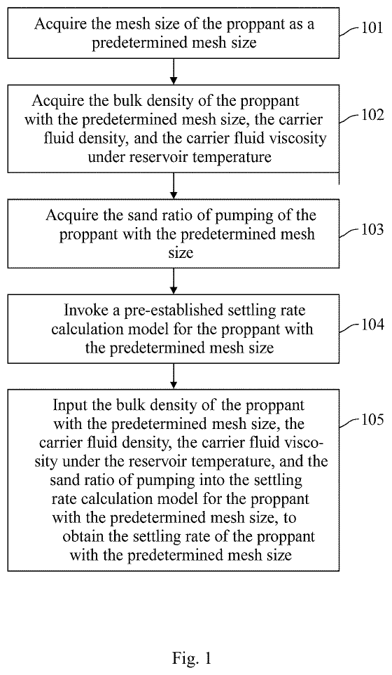

FIG. 1 is a flowchart of one embodiment of the method for determining the settling rate of proppant provided by the present application. Although the present application provides the operation steps or device structure shown in the following embodiments or drawings, additional or fewer operation steps or modules may be included in the method or device without departing from conventional knowledge or requiring creative effort. For steps or structures in which no necessary causal relationship exists logically, the execution sequence of these steps or the structure of the modules is not limited to the execution sequence or module structure described in the embodiments or shown in the drawings. In practical application of the device or terminal product, the method or module structure may be executed sequentially or in parallel according to the embodiments or the structures shown in the drawings (for example, in parallel processing or multithreading environments, or even distributed processing environments).

Specifically, as shown in FIG. 1, the method for determining the settling rate of proppant may include the following steps:
Step 101: acquiring the mesh size of the proppant as a predetermined mesh size;
wherein, the mesh size of the proppant may include, but is not limited to, at least one of: 30/50, 40/70, 70/140, or 100/200.
Step 102: obtaining the bulk density of the proppant with the predetermined mesh size, the density of the carrier fluid, and the viscosity of the carrier fluid at reservoir temperature;
That is, considering that the settling rate of the proppant is affected by the bulk density of the proppant, the density of the carrier fluid, and the viscosity of the carrier fluid at reservoir temperature, in the present embodiment, these parameters need to be obtained.

Wherein, obtaining the viscosity of the carrier fluid at reservoir temperature may comprise:
determining and calculating the viscosity of the carrier fluid at reservoir temperature according to the following formula:

$$μ = {μ}_{0} \cdot {e}^{( T - {T}_{0} ) / {T}_{0}}$$

wherein, μ denotes the viscosity of the carrier fluid under reservoir temperature, μ₀ denotes the viscosity of the carrier fluid under surface temperature, T denotes the temperature of the target formation, T₀ denotes the surface temperature.
Step 103: obtaining a preset sand ratio for pumping the proppant with the predetermined mesh size;
Step 104: retrieving a pre-established settling rate calculation model corresponding to the proppant of the predetermined mesh size;
(1) When the predetermined mesh size of the proppant is 30/50, the corresponding settling rate calculation model may be expressed as:

$${v}_{p 30 / 50} = 11 7.83 lg ( {α}_{30 / 5 {0}^{{m}_{30 / 50}}} \frac{{ρ}_{s 30 / 50}}{{ρ}_{l 30 / 50}} ) {e}^{- {n}_{30 / 50} {μ}_{30 / 50}}$$

wherein, v_{p30/50} denotes the settling rate of the proppant with a mesh size of 30/50, α_{30/50} denotes the sand ratio of the proppant with a mesh size of 30/50 during pumping, m_{30/50} denotes the sand ratio factor of the proppant with a mesh size of 30/50, ρ_{s30/50} denotes the bulk density of the proppant with a mesh size of 30/50, ρ_{l30/50} denotes the density of the carrier fluid for the proppant with a mesh size of 30/50, μ_{30/50} denotes the viscosity factor of the proppant with a mesh size of 30/50; ρ_{30/50} denotes the viscosity of the carrier fluid under reservoir temperature for the proppant with a mesh size of 30/50;
Wherein, the specific values of m_{30/50} and μ_{30/50} may be determined according to actual conditions and experimental results, and are not limited by the present application.
(2) When the predetermined mesh size of the proppant is 40/70, the corresponding settling rate calculation model may be expressed as:

$${v}_{p 40 / 70} = 73.84 lg ( {α}_{40 / 70}^{{m}_{40 / 70}} \frac{{ρ}_{s 40 / 70}}{{ρ}_{l 40 / 70}} ) {e}^{- {n}_{40 / 70} {μ}_{40 / 70}}$$

wherein, v_{p40/70} denotes the settling rate of the proppant with a mesh size of 40/70, α_{40/70} denotes the sand ratio of the proppant with a mesh size of 40/70 during pumping, m_{40/70} denotes the sand ratio factor of the proppant with a mesh size of 40/70, ρ_{s40/70} denotes the bulk density of the proppant with a mesh size of 40/70, ρ_{l40/70} denotes the density of the carrier fluid for the proppant with a mesh size of 40/70, n_{40/70} denotes the viscosity factor of the proppant with a mesh size of 40/70, μ_{40/70} denotes the viscosity of the carrier fluid under reservoir temperature for the proppant with a mesh size of 40/70;
Wherein, the specific values of m_{40/70} and n_{40/70} may be determined according to actual conditions and experimental results, and are not limited by the present application.
(3) When the predetermined mesh size of the proppant is 70/140, the corresponding settling rate calculation model may be expressed as:

$${v}_{p 70 / 140} = 28.34 lg ( {α}_{70 / 140}^{{m}_{70 / 140}} \frac{{ρ}_{s 70 / 140}}{{ρ}_{l 70 / 140}} ) {e}^{- {n}_{70 / 140} {μ}_{70 / 140}}$$

wherein, v_{p70/140} denotes the settling rate of the proppant with a mesh size of 70/140, α_{70/140} denotes the sand ratio of the proppant with a mesh size of 70/140 during pumping, m_{70/140} denotes the sand ratio factor of the proppant with a mesh size of 70/140, ρ_{s70/140} denotes the bulk density of the proppant with a mesh size of 70/140, ρ_{l70/140} denotes the density of the carrier fluid for the proppant with a mesh size of 70/140, n_{70/140} denotes the viscosity factor of the proppant with a mesh size of 70/140, ρ_{70/140} denotes the viscosity of the carrier fluid under reservoir temperature for the proppant with a mesh size of 70/140;
Wherein, the specific values of m_{70/140} and μ_{70/140} may be determined according to actual conditions and experimental results, and are not limited by the present application.
(4) When the predetermined mesh size of the proppant is 100/200, the corresponding settling rate calculation model may be expressed as:

$${V}_{p 100 / 200} = 68.51 lg ( {α}_{100 / 200}^{100 / 200} \frac{{ρ}_{s 10 \; 0 / 200}}{{ρ}_{l 10 \; 0 / 200}} ) {e}^{- {n}_{100 / 200} {μ}_{100 / 200}}$$

wherein, v_{p100/200} denotes the settling rate of the proppant with a mesh size of 100/200, α_{100/200} denotes the sand ratio of the proppant with a mesh size of 100/200 during pumping, m_{100/200} denotes the sand ratio factor of the proppant with a mesh size of 100/200, ρ_{s100/200} denotes the bulk density of the proppant with a mesh size of 100/200, ρ_{l100/200} denotes the density of the carrier fluid for the proppant with a mesh size of 100/200, μ_{100/200} denotes the viscosity factor of the proppant with a mesh size of 100/200, μ_{100/200} denotes the viscosity of the carrier fluid under reservoir temperature for the proppant with a mesh size of 100/200.

Wherein, the specific values of m_{100/200} and μ_{100/200} may be determined according to actual conditions and experimental results, and are not limited by the present application.
Step 105: inputting the bulk density of the proppant with the predetermined mesh size, the density of the carrier fluid, the viscosity of the carrier fluid at reservoir temperature, and the sand ratio into the settling rate calculation model for the predetermined mesh size proppant, and calculating the settling rate of the proppant with the predetermined mesh size.

After calculating the settling rate of the proppant with the predetermined mesh size in the above manner, it may be determined whether the calculated settling rate of the proppant with the predetermined mesh size meets a preset settling rate requirement; if it is determined that the calculated settling rate of the proppant with the predetermined mesh size does not meet the preset settling rate requirement, the mesh size of the proppant may be reselected; and the settling rate is determined based on the reselected mesh size of the proppant until the settling rate meets the preset settling rate requirement.

A specific embodiment of the above method will be described below. However, it should be noted that this specific embodiment is provided only to better illustrate the present application and should not be construed as unduly limiting the present application.

In the present embodiment, a proppant settling rate calculation model is provided. The proppant settling rate model is established based on factors such as proppant particle size and carrier fluid viscosity, primarily considering that the main factors affecting the placement effect of proppant in the fracture are the slurry velocity, carrier fluid viscosity, and sand ratio. Therefore, in order to maximize hydrocarbon production, hydraulic fracturing requires precise configuration of proppant particle size (mesh size), density, carrier fluid density/viscosity, and settling rate.

Specifically, a method for determining the settling rate of proppant is provided, which enables accurate determination of the settling rate of the proppant, and allows adjustment of the settling rate by changing the particle size, density, carrier fluid density, and carrier fluid viscosity of the proppant, thereby providing a theoretical basis and design reference for efficiently constructing fracture conductivity in unconventional reservoir hydraulic fracturing.

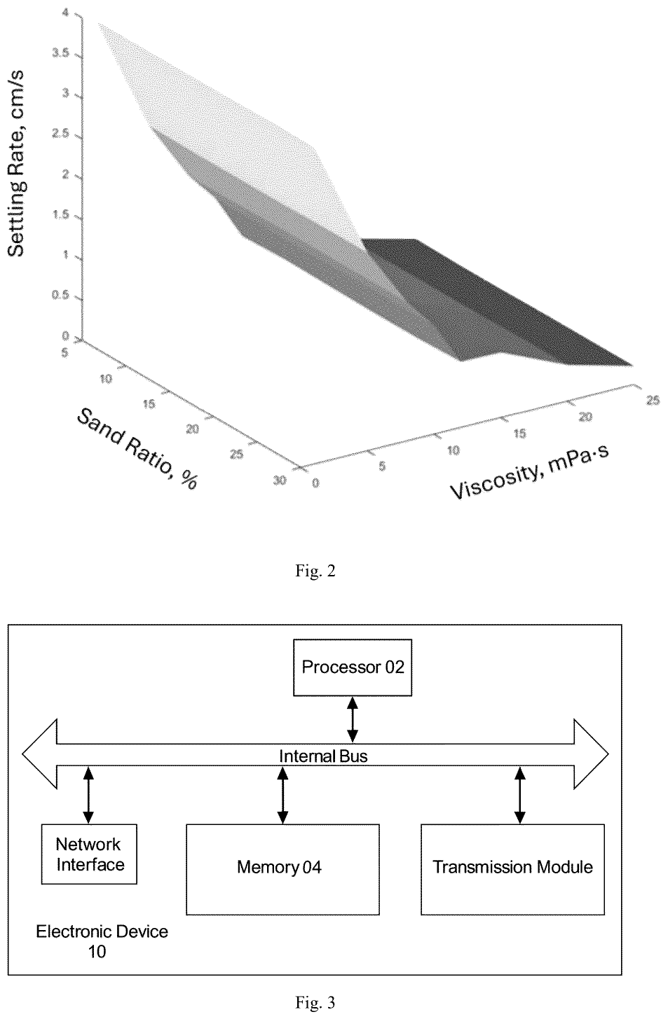

The established settling rate calculation model may be expressed as:

$${v}_{p 30 / 50} = 117.83 lg ( {α}_{30 / 50}^{{m}_{30 / 50}} \frac{{ρ}_{s 30 / 50}}{{ρ}_{l 30 / 50}} ) {e}^{- {n}_{30 / 50} {μ}_{30 / 50}}$$

$${v}_{p 40 / 70} = 73.84 lg ( {α}_{40 / 70}^{{m}_{40 / 70}} \frac{{ρ}_{s 40 / 70}}{{ρ}_{l 40 / 70}} ) {e}^{- {n}_{40 / 70} {μ}_{40 / 70}}$$

$${v}_{p 70 / 140} = 28.34 lg ( {α}_{70 / 140}^{{m}_{70 / 140}} \frac{{ρ}_{s 70 / 140}}{{ρ}_{l 70 / 140}} ) {e}^{- {n}_{70 / 140} {μ}_{70 / 140}}$$

$${V}_{p 100 / 200} = 68.51 lg ( {α}_{100 / 200}^{{m}_{100 / 200}} \frac{{ρ}_{s 10 \; 0 / 200}}{{ρ}_{l 10 \; 0 / 200}} ) {e}^{- {n}_{100 / 200} {μ}_{100 / 200}}$$

wherein, v_{p30/50} denotes the settling rate of the proppant with a mesh size of 30/50, α_{30/50} denotes the sand ratio of the proppant with a mesh size of 30/50 during pumping, m_{30/50} denotes the sand ratio factor of the proppant with a mesh size of 30/50, ρ_{s30/50} denotes the bulk density of the proppant with a mesh size of 30/50, ρ_{l30/50} denotes the density of the carrier fluid for the proppant with a mesh size of 30/50, n_{30/50} denotes the viscosity factor of the proppant with a mesh size of 30/50; μ_{30/50} denotes the viscosity of the carrier fluid under reservoir temperature for the proppant with a mesh size of 30/50; wherein, v_{p40/70} denotes the settling rate of the proppant with a mesh size of 40/70, α_{40/70} denotes the sand ratio of the proppant with a mesh size of 40/70 during pumping, m_{40/70} denotes the sand ratio factor of the proppant with a mesh size of 40/70, ρ_{s40/70} denotes the bulk density of the proppant with a mesh size of 40/70, ρ_{l40/70} denotes the density of the carrier fluid for the proppant with a mesh size of 40/70, μ_{40/70} denotes the viscosity factor of the proppant with a mesh size of 40/70, ρ_{40/70} denotes the viscosity of the carrier fluid under reservoir temperature for the proppant with a mesh size of 40/70; wherein, v_{p70/140} denotes the settling rate of the proppant with a mesh size of 70/140, α_{70/140} denotes the sand ratio of the proppant with a mesh size of 70/140 during pumping, m_{70/140} denotes the sand ratio factor of the proppant with a mesh size of 70/140, ρ_{s70/140} denotes the bulk density of the proppant with a mesh size of 70/140, ρ_{l70/140} denotes the density of the carrier fluid for the proppant with a mesh size of 70/140, μ_{70/140} denotes the viscosity factor of the proppant with a mesh size of 70/140, ρ_{70/140} denotes the viscosity of the carrier fluid under reservoir temperature for the proppant with a mesh size of 70/140; wherein, v_{p100/200} denotes the settling rate of the proppant with a mesh size of 100/200, α₁₀₀₁₂₀₀ denotes the sand ratio of the proppant with a mesh size of 100/200 during pumping, m_{100/200} denotes the sand ratio factor of the proppant with a mesh size of 100/200, ρ_{s100/200} denotes the bulk density of the proppant with a mesh size of 100/200, ρ_{l100/200} denotes the density of the carrier fluid for the proppant with a mesh size of 100/200, n_{100/200} denotes the viscosity factor of the proppant with a mesh size of 100/200, μ_{100/200} denotes the viscosity of the carrier fluid under reservoir temperature for the proppant with a mesh size of 100/200, represents the logarithm to base 10;
For the settling rate, in implementation, the mesh size of the proppant may first be determined, for example, 30/50. Then, the bulk density of the proppant, the density of the carrier fluid, and the viscosity of the carrier fluid at reservoir temperature are obtained. Further, a target sand ratio for pumping the proppant is set to calculate the corresponding settling rate under the given sand ratio. If the calculated settling rate does not meet the preset settling rate requirement, the mesh size of the proppant (for example, changing from 30/50 to 40/70) may be reselected, or the bulk density of the proppant may be reduced, the density of the carrier fluid may be increased, or the viscosity of the carrier fluid at reservoir temperature may be increased, and the settling rate may be recalculated repeatedly until the settling rate meets the preset requirement. That is, after calculating the settling rate of the proppant with the predetermined mesh size, it may be determined whether the calculated settling rate meets the preset requirement; if not, the mesh size of the proppant may be reselected, or one or more of the bulk density of the proppant, the density of the carrier fluid, and the viscosity of the carrier fluid at reservoir temperature may be adjusted; and the settling rate is determined based on the reselected mesh size or the adjusted parameters until it meets the preset requirement. As shown in FIG. 2, it is a schematic diagram of the relationship among settling rate, sand ratio, and viscosity.

In the above embodiment, a method for determining the settling rate of proppant is provided, which enables accurate design of the proppant settling rate in unconventional hydraulic fracturing. The settling rate may also be adjusted by changing the proppant particle size, density, carrier fluid density, and carrier fluid viscosity, thereby providing a theoretical basis and design reference for efficiently constructing fracture conductivity in unconventional reservoir hydraulic fracturing.

The method embodiments provided in the present application may be executed on mobile terminals, computer terminals, or similar computing devices. Taking operation on an electronic device as an example, FIG. 3 is a hardware block diagram of an electronic device for determining the settling rate of proppant provided by the present application. As shown in FIG. 3, the electronic device 10 may include one or more (only one is shown in the figure) processors 02 (the processor 02 may include but is not limited to a processing device such as a microprocessor MCU or a programmable logic device FPGA), a memory 04 for storing data, and a transmission module 06 for communication functions. It will be understood by those skilled in the art that the structure shown in FIG. 3 is illustrative only and does not limit the structure of the electronic device described above. For example, the electronic device 10 may include more or fewer components than shown in FIG. 3, or may have a different configuration.

The memory 04 may be used to store software programs and modules of application software, such as program instructions/modules corresponding to the method for determining the settling rate of proppant as described in the embodiments of the present application. The processor 02 executes various function applications and data processing by running the software programs and modules stored in the memory 04, thereby implementing the method for determining the settling rate of proppant. The memory 04 may include high-speed random access memory and may also include non-volatile memory, such as one or more magnetic storage devices, flash memory, or other non-volatile solid-state storage devices. In some instances, the memory 04 may further include a memory remotely located relative to the processor 02, which may be connected to the electronic device 10 through a network. Examples of the network include, but are not limited to, the Internet, intranets, local area networks, mobile communication networks, and combinations thereof.

The transmission module 06 is configured to receive or transmit data via a network. Specific examples of the network may include a wireless network provided by the communication service provider of the electronic device 10. In one example, the transmission module 06 includes a Network Interface Controller (NIC), which may be connected to other network devices through a base station to communicate with the Internet. In one example, the transmission module 06 may be a Radio Frequency (RF) module for communicating wirelessly with the Internet.

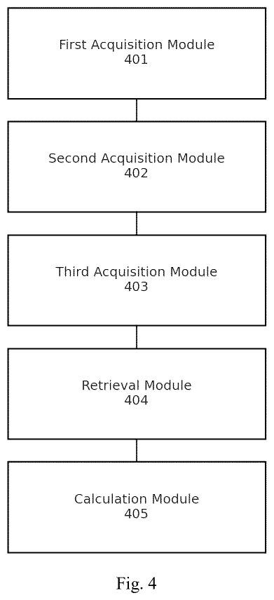

At the software level, the device for determining the settling rate of proppant may include, as shown in FIG. 4:
a first acquisition module 401, configured to acquire the mesh size of the proppant as a predetermined mesh size;
a second acquisition module 402, configured to acquire the bulk density of the proppant with the predetermined mesh size, the density of the carrier fluid, and the viscosity of the carrier fluid at reservoir temperature;
a third acquisition module 403, configured to acquire a preset sand ratio for pumping the proppant with the predetermined mesh size;
a retrieval module 404, configured to retrieve a pre-established settling rate calculation model corresponding to the proppant of the predetermined mesh size;
a calculation module 405, configured to input the bulk density of the proppant with the predetermined mesh size, the carrier fluid density, the viscosity of the carrier fluid at reservoir temperature, and the sand ratio into the settling rate calculation model for the predetermined mesh size proppant, so as to calculate the settling rate of the proppant with the predetermined mesh size.

In one embodiment, the second acquisition module 402 is specifically configured to determine and calculate the viscosity of the carrier fluid at reservoir temperature according to the following formula:

$$μ = {μ}_{0} \cdot {e}^{( T - {T}_{0} ) / {T}_{0}}$$

wherein, μ denotes the viscosity of the carrier fluid under reservoir temperature, μ₀ denotes the viscosity of the carrier fluid under surface temperature, T denotes the temperature of the target formation, T₀ denotes the surface temperature.

In one embodiment, the mesh size of the proppant may include, but is not limited to, at least one of: 30/50, 40/70, 70/140, or 100/200.

In one embodiment, the settling rate calculation model for the proppant with the predetermined mesh size may comprise:
when the predetermined mesh size of the proppant is 30/50, the corresponding settling rate calculation model is expressed as:

$${v}_{p 30 / 50} = 117.83 lg ( {α}_{30 / 50}^{{m}_{30 / 50}} \frac{{ρ}_{s 30 / 50}}{{ρ}_{l 30 / 50}} ) {e}^{- {n}_{30 / 50} {μ}_{30 / 50}}$$

wherein, v_{p30/50} denotes the settling rate of the proppant with a mesh size of 30/50, α_{30/50} denotes the sand ratio of the proppant with a mesh size of 30/50 during pumping, m_{30/50} denotes the sand ratio factor of the proppant with a mesh size of 30/50, ρ_{s30/50} denotes the bulk density of the proppant with a mesh size of 30/50, ρ_{l30/50} denotes the density of the carrier fluid for the proppant with a mesh size of 30/50, μ_{30/50} denotes the viscosity factor of the proppant with a mesh size of 30/50; ρ_{30/50} denotes the viscosity of the carrier fluid under reservoir temperature for the proppant with a mesh size of 30/50;
when the predetermined mesh size of the proppant is 40/70, the corresponding settling rate calculation model is expressed as:

$${v}_{p 40 / 70} = 73.84 lg ( {α}_{40 / 70}^{{m}_{40 / 70}} \frac{{ρ}_{s 40 / 70}}{{ρ}_{l 40 / 70}} ) {e}^{- {n}_{40 / 70} {μ}_{40 / 70}}$$

wherein, v_{p40/70} denotes the settling rate of the proppant with a mesh size of 40/70, α_{40/70} denotes the sand ratio of the proppant with a mesh size of 40/70 during pumping, m_{40/70} denotes the sand ratio factor of the proppant with a mesh size of 40/70, ρ_{s40/70} denotes the bulk density of the proppant with a mesh size of 40/70, ρ_{l40/70} denotes the density of the carrier fluid for the proppant with a mesh size of 40/70, μ_{40/70} denotes the viscosity factor of the proppant with a mesh size of 40/70, μ_{40/70} denotes the viscosity of the carrier fluid under reservoir temperature for the proppant with a mesh size of 40/70;
when the predetermined mesh size of the proppant is 70/140, the corresponding settling rate calculation model is expressed as:

$${v}_{p 70 / 140} = 28.34 lg ( {α}_{70 / 140}^{{m}_{70 / 140}} \frac{{ρ}_{s 70 / 140}}{{ρ}_{l 70 / 140}} ) {e}^{- {n}_{70 / 140} {μ}_{70 / 140}}$$

wherein, v_{p70/140} denotes the settling rate of the proppant with a mesh size of 70/140, α_{70/140} denotes the sand ratio of the proppant with a mesh size of 70/140 during pumping, m_{70/140} denotes the sand ratio factor of the proppant with a mesh size of 70/140, ρ_{s70/140} denotes the bulk density of the proppant with a mesh size of 70/140, ρ_{l70/140} denotes the density of the carrier fluid for the proppant with a mesh size of 70/140, μ_{70/140} denotes the viscosity factor of the proppant with a mesh size of 70/140, ρ_{70/140} denotes the viscosity of the carrier fluid under reservoir temperature for the proppant with a mesh size of 70/140;
when the predetermined mesh size of the proppant is 100/200, the corresponding settling rate calculation model is expressed as:

$${v}_{p 100 / 200} = 68.51 lg ( {α}_{100 / 200}^{{m}_{100 / 200}} \frac{{ρ}_{s 10 \; 0 / 200}}{{ρ}_{l 10 \; 0 / 200}} ) {e}^{- {n}_{100 / 200} {μ}_{100 / 200}}$$

wherein, v_{p100/200} denotes the settling rate of the proppant with a mesh size of 100/200, α_{100/200} denotes the sand ratio of the proppant with a mesh size of 100/200 during pumping, m_{100/200} denotes the sand ratio factor of the proppant with a mesh size of 100/200, ρ_{s100/200} denotes the bulk density of the proppant with a mesh size of 100/200, ρ_{l100/200} denotes the density of the carrier fluid for the proppant with a mesh size of 100/200, n_{100/200} denotes the viscosity factor of the proppant with a mesh size of 100/200, μ_{100/200} denotes the viscosity of the carrier fluid under reservoir temperature for the proppant with a mesh size of 100/200.

In one embodiment, after calculating the settling rate of the proppant with the predetermined mesh size, the device for determining the settling rate of proppant may further determine whether the calculated settling rate of the proppant with the predetermined mesh size meets a preset settling rate requirement; if it is determined that the calculated settling rate does not meet the preset settling rate requirement, the mesh size of the proppant may be reselected, or one or more of the bulk density of the proppant, the density of the carrier fluid, and the viscosity of the carrier fluid at reservoir temperature may be adjusted; and the settling rate is determined based on the reselected mesh size or the adjusted parameters until the settling rate meets the preset settling rate requirement.

The embodiments of the present application further provide a specific embodiment of an electronic device capable of implementing all steps of the method for determining the settling rate of proppant described in the above embodiments. The electronic device specifically comprises: a processor, a memory, a communications interface, and a bus; wherein the processor, memory, and communications interface communicate with each other via the bus; the processor is configured to call a computer program stored in the memory, and when executing the computer program, the processor performs all steps of the method for determining the settling rate of proppant as described in the embodiments above, for example, performing the following steps:
Step 1: acquiring the mesh size of the proppant as a predetermined mesh size;
Step 2: obtaining the bulk density of the proppant with the predetermined mesh size, the density of the carrier fluid, and the viscosity of the carrier fluid at reservoir temperature;
Step 3: obtaining a preset sand ratio for pumping the proppant with the predetermined mesh size;
Step 4: retrieving a pre-established settling rate calculation model corresponding to the proppant of the predetermined mesh size;
Step 5: inputting the bulk density of the proppant with the predetermined mesh size, the carrier fluid density, the viscosity of the carrier fluid at reservoir temperature, and the sand ratio into the settling rate calculation model for the predetermined mesh size proppant, and calculating the settling rate of the proppant with the predetermined mesh size.

The embodiments of the present application further provide a computer-readable storage medium capable of performing all steps of the method for determining the settling rate of proppant described in the above embodiments. A computer program is stored on the computer-readable storage medium, and when executed by a processor, the computer program performs all steps of the method for determining the settling rate of proppant described in the above embodiments, for example, performing the following steps:
Step 1: acquiring the mesh size of the proppant as a predetermined mesh size;
Step 2: obtaining the bulk density of the proppant with the predetermined mesh size, the density of the carrier fluid, and the viscosity of the carrier fluid at reservoir temperature;
Step 3: obtaining a preset sand ratio for pumping the proppant with the predetermined mesh size;
Step 4: retrieving a pre-established settling rate calculation model corresponding to the proppant of the predetermined mesh size;
Step 5: inputting the bulk density of the proppant with the predetermined mesh size, the carrier fluid density, the viscosity of the carrier fluid at reservoir temperature, and the sand ratio into the settling rate calculation model for the predetermined mesh size proppant, and calculating the settling rate of the proppant with the predetermined mesh size.

From the above description, it can be seen that in the embodiments of the present application, the mesh size of the proppant is first acquired as the predetermined mesh size. Then, the bulk density of the proppant with the predetermined mesh size, the density of the carrier fluid, and the viscosity of the carrier fluid at reservoir temperature are obtained. Further, a preset sand ratio for pumping the proppant with the predetermined mesh size is obtained. The pre-established settling rate calculation model corresponding to the proppant of the predetermined mesh size is then retrieved. The bulk density of the proppant, the carrier fluid density, the viscosity of the carrier fluid at reservoir temperature, and the sand ratio are input into the settling rate calculation model of the predetermined mesh size proppant to calculate the settling rate of the proppant with the predetermined mesh size. That is, the settling rate is determined by combining parameters such as the bulk density of the proppant, the carrier fluid density, and the viscosity of the carrier fluid at reservoir temperature, thereby solving the technical problem in the prior art of poor proppant placement effect caused by the inability to accurately determine the settling rate of proppant, and achieving the technical effect of accurately determining the settling rate to improve the proppant placement effect.

The various embodiments in this specification are described in a progressive manner, with the same or similar parts referred to each other among the embodiments, and each embodiment focuses on the differences from the other embodiments. Especially for hardware+software program embodiments, since they are substantially similar to the method embodiments, the descriptions are relatively simplified, and the relevant parts can be referred to in the method embodiments.

The specific embodiments of the present specification have been described above. Other embodiments fall within the scope of the appended claims. In some cases, the actions or steps recited in the claims may be performed in a different order than that described in the embodiments and still achieve the desired results. In addition, the processes depicted in the drawings do not necessarily require the specific or sequential order shown to achieve the desired results. In certain embodiments, multitasking and parallel processing are also possible or may be advantageous.

Although the methods as described in the embodiments or flowcharts are provided in the present application, more or fewer operation steps may be included based on conventional knowledge or without creative efforts. The sequence of steps listed in the embodiments is only one way of executing multiple steps and does not represent the only execution sequence. In practical devices or client product execution, the methods may be executed sequentially or in parallel according to the embodiments or as shown in the drawings (for example, in parallel processors or multithreading environments).

Although the method operation steps as described in the embodiments or flowcharts are provided in the present specification, more or fewer operation steps may be included based on conventional knowledge or without creative efforts. The sequence of steps listed in the embodiments is only one way of executing multiple steps and does not represent the only execution sequence. In practical devices or terminal product execution, the methods may be executed sequentially or in parallel according to the embodiments or as shown in the drawings (for example, in parallel processors, multithreading environments, or even distributed data processing environments). The terms “comprise”, “comprising” or any variation thereof are intended to cover a non-exclusive inclusion, such that a process, method, product, or device that comprises a list of elements does not include only those elements but may include other elements not explicitly listed or inherent to such process, method, product, or device. Unless otherwise stated, the presence of additional elements in the process, method, product, or device that comprises the listed elements is not excluded.

For the sake of convenience in description, the above device is described by dividing its functions into various modules. Of course, in the implementation of the embodiments of this specification, the functions of each module may be implemented in one or more pieces of software and/or hardware, or the modules performing the same function may be implemented by combinations of multiple sub-modules or sub-units. The device embodiments described above are merely illustrative. For example, the division of units is merely one type of logical functional division, and in actual implementation, other division methods may be adopted. For example, multiple units or components may be combined or integrated into another system, or certain features may be omitted or not executed. In addition, the coupling, direct coupling, or communication connection shown or discussed may be indirect coupling or communication connection through certain interfaces, devices, or units, and may be electrical, mechanical, or in other forms.

It is also known to those skilled in the art that, apart from implementing the controller purely by computer-readable program code, the same function can be achieved by programming the method steps in logic to realize the controller in the form of logic gates, switches, application-specific integrated circuits (ASICs), programmable logic controllers (PLCs), and embedded microcontrollers. Therefore, such a controller may be regarded as a hardware component, and the devices included therein for implementing various functions may also be regarded as structures within the hardware component. Alternatively, the devices for implementing various functions may be regarded as either software modules that implement methods or structures within hardware components.

The present application is described with reference to the flowcharts and/or block diagrams of the methods, devices (systems), and computer program products according to embodiments of the present application. It should be understood that each flow and/or block in the flowcharts and/or block diagrams, as well as combinations of flows and/or blocks, may be implemented by computer program instructions. These computer program instructions may be provided to a general-purpose computer, a special-purpose computer, an embedded processor, or other programmable data processing apparatus to produce a machine, such that the instructions executed by the processor of the computer or other programmable data processing apparatus create means for implementing the functions specified in one or more flows or blocks of the flowcharts and/or block diagrams.

It should be understood by those skilled in the art that the embodiments described in this specification may be provided as methods, systems, or computer program products. Therefore, the embodiments of this specification may take the form of entirely hardware embodiments, entirely software embodiments, or embodiments combining software and hardware aspects. Moreover, the embodiments of this specification may take the form of a computer program product embodied on one or more computer-usable storage media containing computer-usable program code, including magnetic storage, CD-ROM, optical storage, or other non-volatile storage media.

The embodiments of this specification may be described in the general context of computer-executable instructions executed by a computer, such as program modules. Generally, program modules include routines, programs, objects, components, data structures, and other structures that perform particular tasks or implement particular abstract data types. The embodiments of this specification may also be practiced in distributed computing environments where tasks are performed by remote processing devices that are connected through a communication network. In distributed computing environments, program modules may be located in both local and remote computer storage media, including storage devices.

The various embodiments in this specification are described in a progressive manner, and the same or similar parts among the embodiments refer to each other, with each embodiment focusing on the differences from other embodiments. Especially for system embodiments, since they are substantially similar to method embodiments, the descriptions are relatively brief, and relevant parts may refer to the descriptions in the method embodiments. In this specification, reference to terms such as “one embodiment,” “some embodiments,” “examples,” “specific examples,” or “certain examples” means that the specific features, structures, materials, or characteristics described in connection with the embodiment or example are included in at least one embodiment or example of this specification. In this specification, the illustrative expression of the above terms may not necessarily refer to the same embodiment or example. Moreover, the described specific features, structures, materials, or characteristics may be combined in suitable ways in one or more embodiments or examples. Furthermore, provided that there is no conflict, those skilled in the art may combine and integrate the different embodiments or examples described in this specification, as well as the features of different embodiments or examples.

The above descriptions are merely illustrative of the embodiments of this specification and are not intended to limit the embodiments. Those skilled in the art may make various modifications and changes to the embodiments. Any modifications, equivalent substitutions, improvements, or alterations made within the spirit and principle of the embodiments of this specification shall fall within the scope of protection of the embodiments of this specification.

1. A method for determining and regulating the settling rate of a proppant in a hydraulic fracturing operation, characterized in that, the method comprises:
(1) acquiring the mesh size of the proppant as a predetermined mesh size;
(2) obtaining the bulk density of the proppant with the predetermined mesh size, the density of a carrier fluid, and the viscosity of the carrier fluid under reservoir temperature;
(3) obtaining a preset sand ratio for pumping the proppant with the predetermined mesh size;
(4) calculating the viscosity of the carrier fluid under reservoir temperature according to
$$μ = {μ}_{0} \cdot {e}^{( T - {T}_{0} ) / {T}_{0}}$$
wherein, μ denotes the viscosity of the carrier fluid under reservoir temperature, μ₀ denotes the viscosity of the carrier fluid under surface temperature, T denotes the temperature of the target formation, T₀ denotes the surface temperature;
(5) retrieving a pre-established settling rate calculation model corresponding to the predetermined mesh size of the proppant, wherein:
i) when the mesh size is 30/50, the settling rate is calculated according to
$${v}_{p 30 / 50} = 117.83 lg ( {α}_{30 / 50}^{{m}_{30 / 50}} \frac{{ρ}_{s 30 / 50}}{{ρ}_{l 30 / 50}} ) {e}^{- {n}_{30 / 50} {μ}_{30 / 50}}$$
wherein, v_{p30/50} denotes the settling rate of the proppant with a mesh size of 30/50, α_{30/50} denotes the sand ratio of the proppant with a mesh size of 30/50 during pumping, m_{30/50} denotes the sand ratio factor of the proppant with a mesh size of 30/50, ρ_{s30/50} denotes the bulk density of the proppant with a mesh size of 30/50, ρ_{l30/50} denotes the density of the carrier fluid for the proppant with a mesh size of 30/50, μ_{30/50} denotes the viscosity factor of the proppant with a mesh size of 30/50; ρ_{30/50} denotes the viscosity of the carrier fluid under reservoir temperature for the proppant with a mesh size of 30/50;
ii) when the mesh size is 40/70, the settling rate is calculated according to
$${v}_{p 40 / 70} = 73.84 lg ( {α}_{40 / 70}^{{m}_{40 / 70}} \frac{{ρ}_{s 40 / 70}}{{ρ}_{l 40 / 70}} ) {e}^{- {n}_{40 / 70} {μ}_{40 / 70}}$$
wherein, v_{p40/70} denotes the settling rate of the proppant with a mesh size of 40/70, α_{40/70} denotes the sand ratio of the proppant with a mesh size of 40/70 during pumping, m_{40/70} denotes the sand ratio factor of the proppant with a mesh size of 40/70, ρ_{s40/70} denotes the bulk density of the proppant with a mesh size of 40/70, ρ_{l40/70} denotes the density of the carrier fluid for the proppant with a mesh size of 40/70, μ_{40/70} denotes the viscosity factor of the proppant with a mesh size of 40/70, ρ_{40/70} denotes the viscosity of the carrier fluid under reservoir temperature for the proppant with a mesh size of 40/70;
iii) when the mesh size is 70/140, the settling rate is calculated according to
$${v}_{p 70 / 140} = 28.34 lg ( {α}_{70 / 140}^{{m}_{70 / 140}} \frac{{ρ}_{s 70 / 140}}{{ρ}_{l 70 / 140}} ) {e}^{- {n}_{70 / 140} {μ}_{70 / 140}}$$
wherein, v_{p70/140} denotes the settling rate of the proppant with a mesh size of 70/140, α_{70/140} denotes the sand ratio of the proppant with a mesh size of 70/140 during pumping, m_{70/140} denotes the sand ratio factor of the proppant with a mesh size of 70/140, ρ_{s70/140} denotes the bulk density of the proppant with a mesh size of 70/140, ρ_{l70/140} denotes the density of the carrier fluid for the proppant with a mesh size of 70/140, μ_{70/140} denotes the viscosity factor of the proppant with a mesh size of 70/140, ρ_{70/140} denotes the viscosity of the carrier fluid under reservoir temperature for the proppant with a mesh size of 70/140;
iv) when the mesh size is 100/200, the settling rate is calculated according to
$${v}_{p 100 / 200} = 68.51 lg ( {α}_{100 / 200}^{{m}_{100 / 200}} \frac{{ρ}_{s 10 \; 0 / 200}}{{ρ}_{l 10 \; 0 / 200}} ) {e}^{- {n}_{100 / 200} {μ}_{100 / 200}}$$
wherein, v_{p100/200} denotes the settling rate of the proppant with a mesh size of 100/200, α_{100/200} denotes the sand ratio of the proppant with a mesh size of 100/200 during pumping, m_{100/200} denotes the sand ratio factor of the proppant with a mesh size of 100/200, ρ_{s100/200} denotes the bulk density of the proppant with a mesh size of 100/200, ρ_{l100/200} denotes the density of the carrier fluid for the proppant with a mesh size of 100/200, μ_{100/200} denotes the viscosity factor of the proppant with a mesh size of 100/200, μ_{100/200} denotes the viscosity of the carrier fluid under reservoir temperature for the proppant with a mesh size of 100/200;
Each of said formulas defines the settling rate as a function of the proppant bulk density, the carrier fluid density, the sand ratio, the sand ratio factor, the viscosity of the carrier fluid at reservoir temperature, and the viscosity factor;
(6) calculating the settling rate of the proppant using the retrieved model by inputting the bulk density of the proppant, the density of the carrier fluid, the sand ratio, and the viscosity of the carrier fluid under reservoir temperature;
(7) determining whether the calculated settling rate meets a preset settling rate requirement;
(8) if the calculated settling rate fails to meet the preset requirement, reselecting the mesh size of the proppant, or adjusting at least one of the following: the bulk density of the proppant, the density of the carrier fluid, and the viscosity of the carrier fluid under reservoir temperature;
(9) recalculating the settling rate using the updated parameter(s) until the settling rate meets the preset requirement.

2. A device for determining the settling rate of a proppant, characterized in that, the device comprises: a first acquisition module configured to acquire the mesh size of the proppant as a predetermined mesh size; a second acquisition module configured to acquire the bulk density of the proppant with the predetermined mesh size, the density of the carrier fluid, and the viscosity of the carrier fluid at reservoir temperature; a third acquisition module configured to acquire a preset sand ratio for pumping the proppant with the predetermined mesh size; a retrieval module configured to retrieve a pre-established settling rate calculation model corresponding to the proppant with the predetermined mesh size; a calculation module configured to input the bulk density of the proppant with the predetermined mesh size, the carrier fluid density, the viscosity of the carrier fluid at reservoir temperature, and the sand ratio into the settling rate calculation model of the predetermined mesh size proppant, so as to calculate the settling rate of the proppant with the predetermined mesh size.

3. The device according to claim 2, characterized in that, the second acquisition module is specifically configured to determine and calculate the viscosity of the carrier fluid at reservoir temperature according to the following formula:
$$μ = {μ}_{0} \cdot {e}^{( T - {T}_{0} ) / {T}_{0}}$$
wherein, μ denotes the viscosity of the carrier fluid under reservoir temperature, μ₀ denotes the viscosity of the carrier fluid under surface temperature, T denotes the temperature of the target formation, T₀ denotes the surface temperature.

4. An electronic device, characterized in that, the device comprises a processor and a memory for storing instructions executable by the processor, wherein the processor executes the instructions to perform the steps of claim 1.

5. A computer-readable storage medium, characterized in that, the storage medium stores a computer program or instructions, wherein the computer program or instructions, when executed by a processor, perform the steps of claim 1.
